(19) United States
(12) Patent Application Publication
(10) Pub. No.: US 2008/0274814 A1
(43) Pub. Date: Nov. 6, 2008

(54) Wagering Game Device with Secure Storage Device

(75) Inventors: Mark B. Gagner, West Chicago, IL (US); Craig J. Sylla, Round Lake, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS Gaming Inc., Waukegan, IL (US)

(21) Appl. No.: 12/094,366

(22) PCT Filed: Nov. 22, 2006
(86) PCT No.: PCT/US06/45324

§ 371 Date: May 20, 2008

Related U.S. Application Data
(60) Provisional application No. 60/739,567, filed on Nov. 23, 2005.

(51) Int. Cl. G06F 17/00; A63F 9/24

(52) U.S. Cl. 463/43; 463/20

(57) ABSTRACT

Embodiments of a wagering game device with a secure storage device are described herein. In one embodiment, the wagering game device includes a wagering game processor operable to receive a wager for a wagering game. The wagering game device can also include a main memory operable to store wagering game content associated with the wagering game. The wagering game machine can also include a storage device including an encryption unit operable to encrypt the wagering game content and a storage medium operable to store the wagering game content that has been encrypted by the encryption unit.

### RELATED APPLICATION

This application claims the priority benefit of U.S. Provisional Application Ser. No. 60/739,567 filed Nov. 23, 2005, the contents of which are incorporated herein by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2005, WMS Gaming, Inc.

### FIELD

This invention relates generally to the field of wagering game devices and more particularly to the field of wagering game device storage devices.

### BACKGROUND

A wide variety of computerized wagering game devices are now available to casino operators and players. Computerized wagering game machines range from slot machines to games that are traditionally played live, such as poker, blackjack, roulette, etc. These computerized wagering game machines provide many benefits to game owners and players, including increased reliability over mechanical machines, greater game variety, improved sound and animation, and lower overall management cost.

Wagering game machines and other wagering network devices (e.g., wagering game servers) typically take measures for ensuring that their hardware and software components have not been modified or tampered-with. For example, wagering game machines often include software for verifying digital signatures for all machine components, including both hardware and software components. Wagering game machines and wagering network devices also take measures for preventing copying of wagering game machine hardware and software. For example, wagering game machines often encrypt content stored in wagering game device components.

### BRIEF DESCRIPTION OF THE FIGURES

The present invention is illustrated by way of example and not limitation in the Figures of the accompanying drawings in which:

FIG. 1 is a dataflow diagram illustrating dataflow attendant to encrypting wagering game content in a wagering game machine's storage device, according to example embodiments of the invention;

FIG. 2 is a block diagram illustrating a wagering game device, according to example embodiments of the invention;

FIG. 3 is a block diagram illustrating a wagering game network, according to example embodiments of the invention;

FIG. 4 is a flow diagram illustrating operations for receiving and encrypting wagering game data in a storage device, according to example embodiments of the invention;

FIG. 5 is a flow diagram illustrating operations for retrieving a decrypting wagering in content, according to example embodiments of the invention;

FIG. 6 is a flow diagram illustrating operations with which a wagering game device authenticates a storage device, according to example embodiments of the invention;

FIG. 7 is a flow diagram illustrating operations for a storage device responding to authentication requests in a wagering game machine, according to example embodiments of the invention;

FIG. 8 is a flow diagram illustrating operations for procuring an encryption key for unlocking wagering game content, according to example embodiments of the invention;

FIG. 9 is a flow diagram illustrating operations for using an encryption key for unlocking wagering game content, according to example embodiments of the invention; and

FIG. 10 is a perspective view of a wagering game machine, according to example embodiments of the invention.

### DESCRIPTION OF THE EMBODIMENTS

Embodiments of a wagering game device with a secure storage device are described herein. This description of the embodiments is divided into five sections. The first section provides an introduction to embodiments of the invention. The second section describes example gaming device architectures, while the third section describes example operations performed by some embodiments of the gaming device architectures. The fourth section describes wagering game machines and gaming networks and the fifth section provides some general comments.

### Introduction

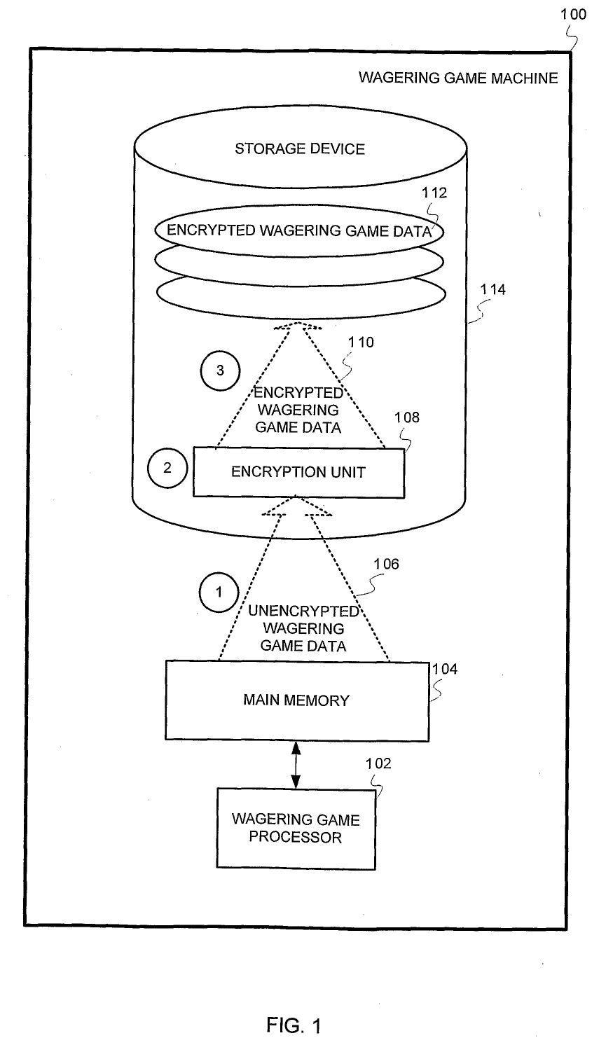

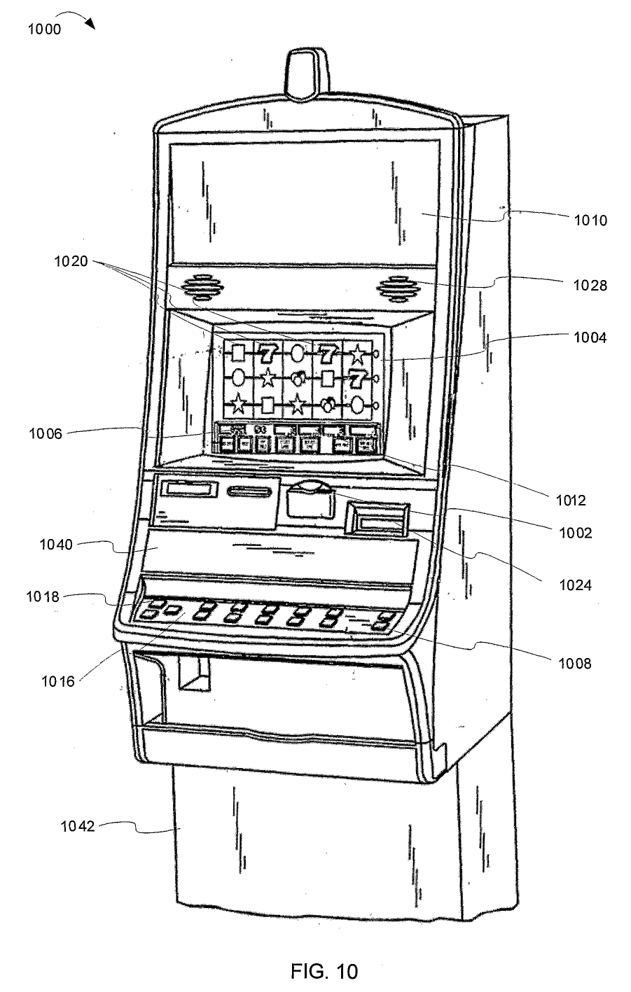

This section introduces embodiments of a wagering game machine that includes a storage device, such as a hard disk drive, capable of encrypting wagering game information without assistance from the wagering game machine's central processing unit (CPU) and/or main memory. The wagering game machine may be a non-portable wagering game machine as illustrated in FIG. 10 below, or the wagering game machine may be a portable or handheld wagering game machine. In one example embodiment, a wagering game machine's hard disk drive (HDD) includes an application specific integrated circuit (ASIC) that can encrypt wagering game content received from the wagering game machine's main memory or other components without the wagering game machine's CPU assisting with the encryption. As a result, the wagering game machine's CPU does not expend resources encrypting content for storage. FIG. 1 describes this in more detail.

FIG. 1 is a dataflow diagram illustrating dataflow attendant to encrypting wagering game content in a wagering game machine's storage device, according to example embodiments of the invention. As shown in FIG. 1, the wagering game machine 100 includes a wagering game processor 102 connected to a main memory 104, which is connected to a storage device 114. A dataflow occurs in three stages.

At stage one, the main memory 104 transmits unencrypted wagering game content 106 to an encryption unit 108, which is located inside the storage device 114.

At stage two, the encryption unit 108 encrypts the unencrypted wagering game content 106, producing encrypted wagering game content 110. The encryption unit 108 can use any suitable encryption algorithm, such as Data Encryption Standard, RSA, Advanced Encryption Standard, etc.

At stage three, the encryption unit 108 stores the encrypted wagering game content 110 on a storage media 112, such as magnetic platters (e.g., a HDD), optical media (e.g., CD-ROM, DVD, etc.), flash memory, or any other medium suitable for storing encrypted wagering game content. In addition to what is shown in FIG. 1, the encryption unit 108 can also decrypt encrypted wagering game content, before it is transmitted to the main memory 104 and/or wagering game processor 102.

These and other embodiments of the invention are described in greater detail below.

### Example Wagering Game Device and Network

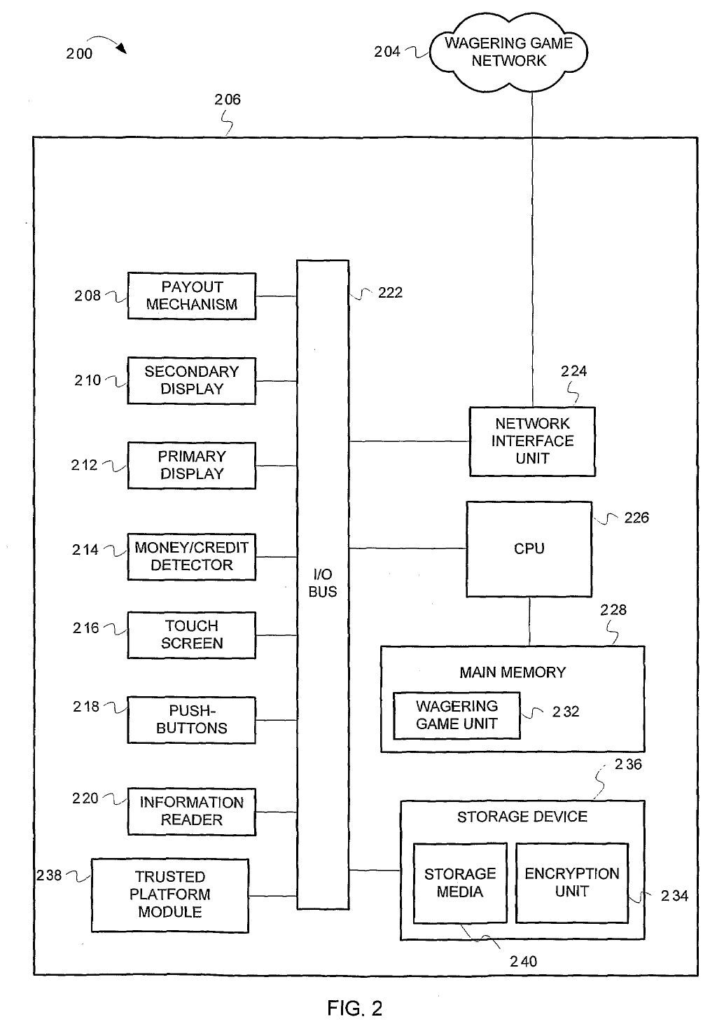

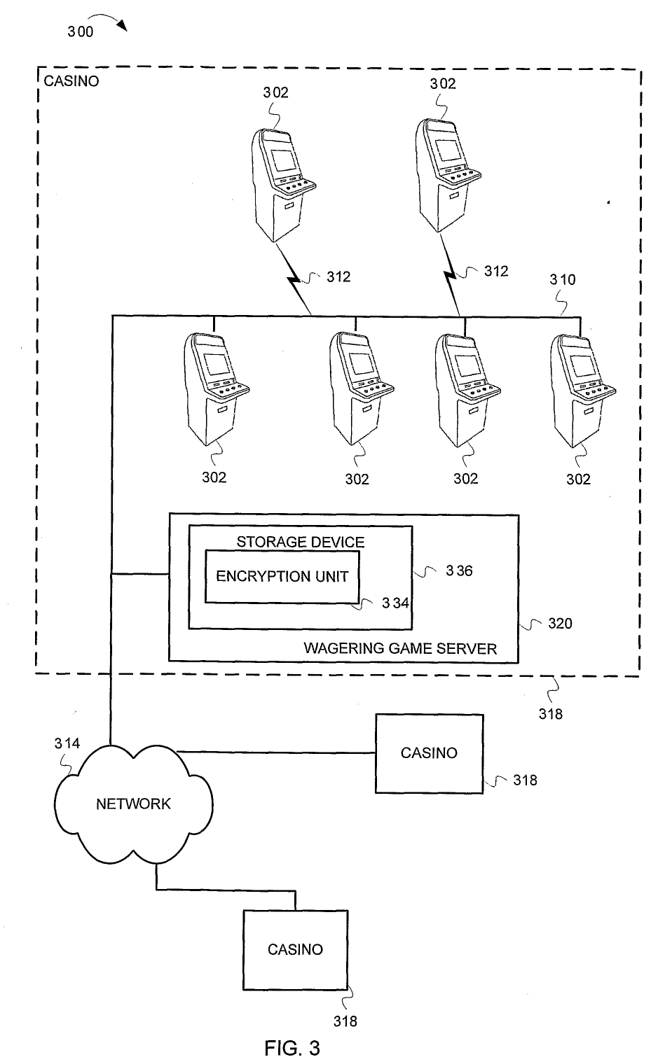

The section describes an example wagering gaming device architecture and wagering game network with which embodiments can be practiced. In particular, FIG. 2 describes an example wagering game machine, whereas FIG. 3 describes an example gaming network. The discussion continues with FIG. 2.

### Example Wagering Game Device

FIG. 2 is a block diagram illustrating a wagering game device, according to example embodiments of the invention. According to embodiments, the wagering game device 206 can operate as a wagering game machine, wagering game server, and/or other suitable device in a wagering game network.

As shown in FIG. 2, the wagering game device 206 includes a central processing unit (CPU) 226 connected to a main memory 228. In one embodiment, the wagering game unit 232 can conduct any suitable wagering game, such as video poker, video black jack, video slots, video lottery, etc.

The CPU 226 is also connected to an input/output (I/O) bus 222, which facilitates communication between the wagering game device's components. The I/O bus 222 is connected to a storage unit 236, which includes an encryption unit 234 and storage media 240. The storage media 240 can include magnetic disks, optical media (e.g., CD-ROMs or DVDs), flash memory, or any other media suitable for storing wagering game content. The storage unit 236 can store wagering game content, which can include any information suitable for use by the wagering game device 206 or other wagering network devices on a wagering network (e.g., wagering network game servers, wagering network configuration servers, etc.). For example, the wagering game content can include instructions and/or data for conducting casino style wagering games (e.g., video slots, video poker, video black jack, and the like). In one embodiment, the wagering game content can include program code, audio content, video content, and/or other data used for conducting all or part of a casino style slots game and/or bonus events. The wagering game content can also include executable wagering game code, wagering game math, art, configuration data (e.g., enumerating allowable percentages, denominations, paylines, etc.), wagering device operating system features, peripheral device drivers or other peripheral device code/content, attract mode displays, advertisements, and episodic game content.

The I/O bus 222 is also connected to a payout mechanism 208, secondary display 210, primary display 212, money/credit detector 214, touchscreen 216, push-buttons 218, and information reader 220. The I/O bus 222 is also connected to a network interface unit 224, which is connected to a wagering game network 204. Additionally, the I/O bus is connected to a trusted platform module 238, which can authenticate the wagering game device's components, such as the storage device 236.

In one embodiment, the wagering game device 206 can include additional peripheral devices and/or more than one of each component shown in FIG. 2. For example, in one embodiment, the wagering game device 206 can include multiple network interface units 224 and multiple CPUs 226. In one embodiment, any of the components can be integrated or subdivided. Additionally, in one embodiment, the components of the wagering game machine 206 can be interconnected according to any suitable interconnection architecture (e.g., directly connected, hypercube, etc.).

In one embodiment, any of the components of the wagering game device 206 can include machine-readable media including instructions for performing operations described herein. Machine-readable media includes any mechanism that provides (i.e., stores and/or transmits) information in a form readable by a machine (e.g., a computer). For example, tangible machine-readable media includes read only memory (ROM), random access memory (RAM), magnetic disk storage media, optical storage media, flash memory devices, etc. Furthermore, components of the wagering game device 206 can include other types of logic (e.g., digital logic) for executing the operations described herein.

While the discussion of FIG. 2 describes the various components of a wagering game device, FIG. 3 describes embodiments of a wagering network. This description continues with FIG. 3.

### Example Wagering Game Network

FIG. 3 is a block diagram illustrating a wagering game network, according to example embodiments of the invention. As shown in FIG. 3, the wagering game network 300 includes a plurality of casinos 318 connected to a communications network 314. Each of the plurality of casinos 318 can include networks, which include a plurality of wagering game machines 302 connected to a wagering game server 320 and other suitable wagering network devices (not shown).

As shown in FIG. 3, the wagering game server 320 includes a storage device 336, which includes an encryption unit 334. The storage device 336 and encryption unit 334 can operate in conjunction with the communications network 314 and it can perform operations described herein. In one embodiment, the wagering game machines 302 include storage devices similar to the storage device 336.

The components of each casino 318 can communicate over wired 310 and/or wireless connections 312. Furthermore, they can employ any suitable connection technology, such as Bluetooth, 302.11, Wireless Application Protocol (WAP), Ethernet, public switched telephone networks, etc.

### Operations

This section describes operations performed by embodiments of the invention. In the discussion below, the flow diagrams will be described with reference to the block diagrams presented above. In certain embodiments, the operations are performed by instructions residing on machine-readable media (e.g., software), while in other embodiments, the operations are performed by hardware and/or other logic (e.g., digital logic).

### Encryption

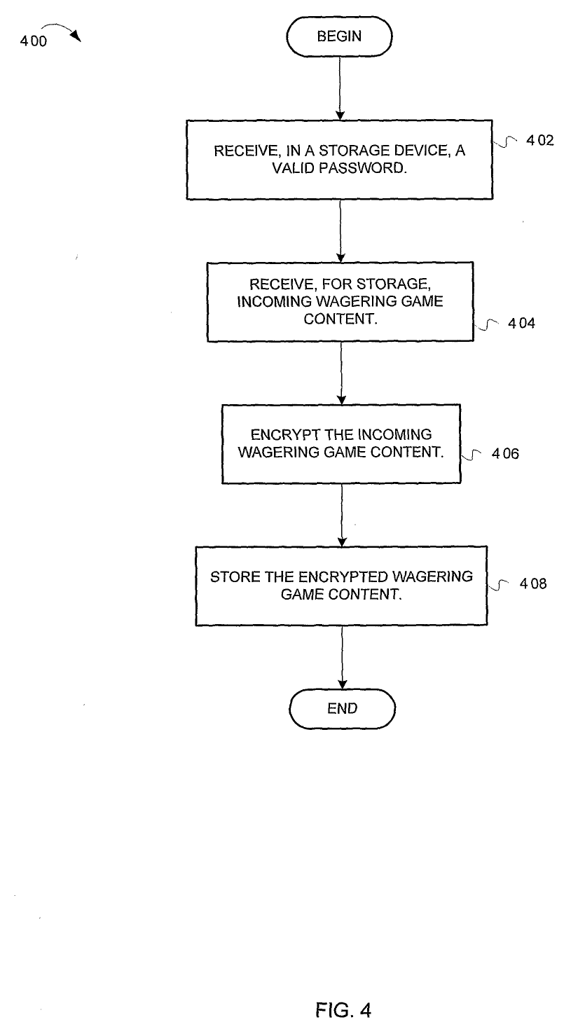

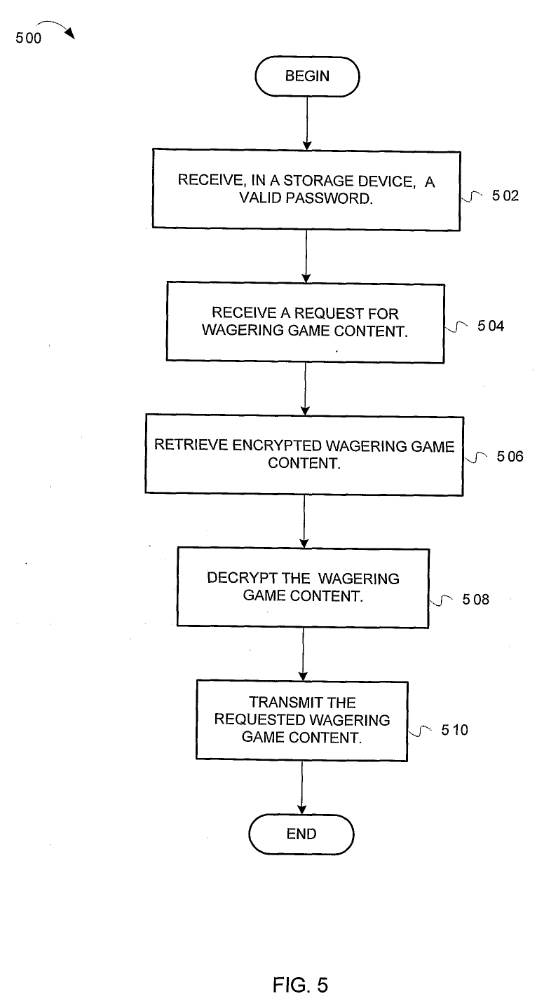

FIGS. 4 and 5 are discussed below. FIG. 4 describes operations for receiving and encrypting wagering game content in a storage device, while FIG. 5 describes operations for decrypting and providing wagering game data for use in wagering device operations. This description will proceed with a discussion of FIG. 4.

FIG. 4 is a flow diagram illustrating operations for receiving and encrypting wagering game data in a storage device, according to example embodiments of the invention. The flow diagram 400 begins at block 402.

At block 402, a valid password is received in a storage device. In one embodiment, before the storage device 236 will encrypt and store data for a particular user, the storage device 236 requires a valid user password, which may be received through a graphical user interface (not shown) and passed-on to the storage device 236. The storage device 236 may receive the valid password from the CPU 226 over the I/O bus 222. In another embodiment, the password in not needed. The flow continues at block 404.

At block 404, incoming wagering game content is received for storage. For example, the storage device 236 receives wagering game content, such as executable wagering game program code, from the main memory 228 and/or the CPU 226. The flow continues at block 406.

At block 406, incoming wagering game content is encrypted. For example, the storage device's encryption unit 234 encrypts the wagering game content. In one embodiment, the encryption unit 234 can encrypt the wagering game content using any suitable encryption technique, such as DES, Triple DES, AES, RSA, etc. In one embodiment, after the storage device's encryption unit 234 receives the wagering game content, it encrypts the content without using the CPU 226 and/or the main memory 228. In one embodiment, the encryption unit 234 can encrypt the wagering game content based on a preprogrammed secret encryption key, a dynamically programmed encryption key, or a combination of the two. The flow continues at block 408.

At block 408, the encrypted wagering game content is stored. For example, the storage device 236 stores the encrypted wagering game content on a storage media 240. From block 408, the flow ends.

While FIG. 4 describes operations for decrypting of storing wagering game content in the storage device 236, FIG. 5 describes operations for retrieving and decrypting the wagering game content. This description continues with FIG. 5.

FIG. 5 is a flow diagram illustrating operations for retrieving and decrypting wagering game content, according to example embodiments of the invention. The flow 500 begins at block 502.

At block 502, a valid password is received in a storage device. In one embodiment, before the storage device 236 will encrypt and store data for a particular user, the storage device 236 requires a valid user password, which can be received through a graphical user interface (not shown). The storage device 236 may receive the valid password from the CPU 226 over the I/O bus 222. In another embodiment, the password is not needed. The flow continues at block 504.

At block 504, a request for wagering game content is received. For example, the storage device 236 receives a request for wagering game content stored on the storage media 240. The flow continues at block 506.

At block 506, an encrypted version of the wagering game content is retrieved. For example, the storage device 236 retrieves the requested wagering game content from the storage media and delivers it to the encryption unit 234. The flow continues at block 508.

At block 508, the encrypted wagering game content is decrypted. For example, the encryption unit 234 decrypts the encrypted wagering game content, producing an unencrypted version of the requested wagering game content. In one embodiment, the encryption unit 234 can decrypt wagering game content that has been encrypted with a suitable encryption technique, such as DES, Triple DES, AES, RSA, etc. Even though the encryption unit 234 decrypts the wagering game content, the content can still include encrypted data (e.g., data that was encrypted by a device other than the storage unit 236). The flow continues at block 510.

At block 510, the requested wagering game content is transmitted. For example, the encryption unit 234 transmits the requested wagering game content to the main memory 228 and/or the CPU 226. Once in the main memory 228, the requested wagering game content is accessible to any one or all of the components of the wagering game device 206. From block 510, the flow ends.

### Authenticating Devices

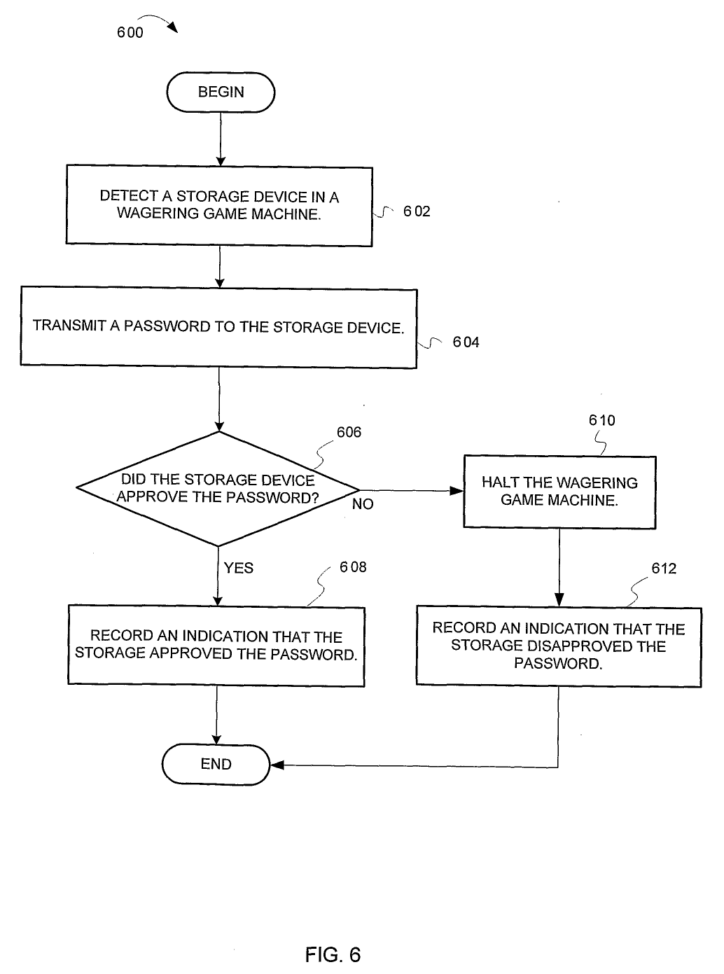

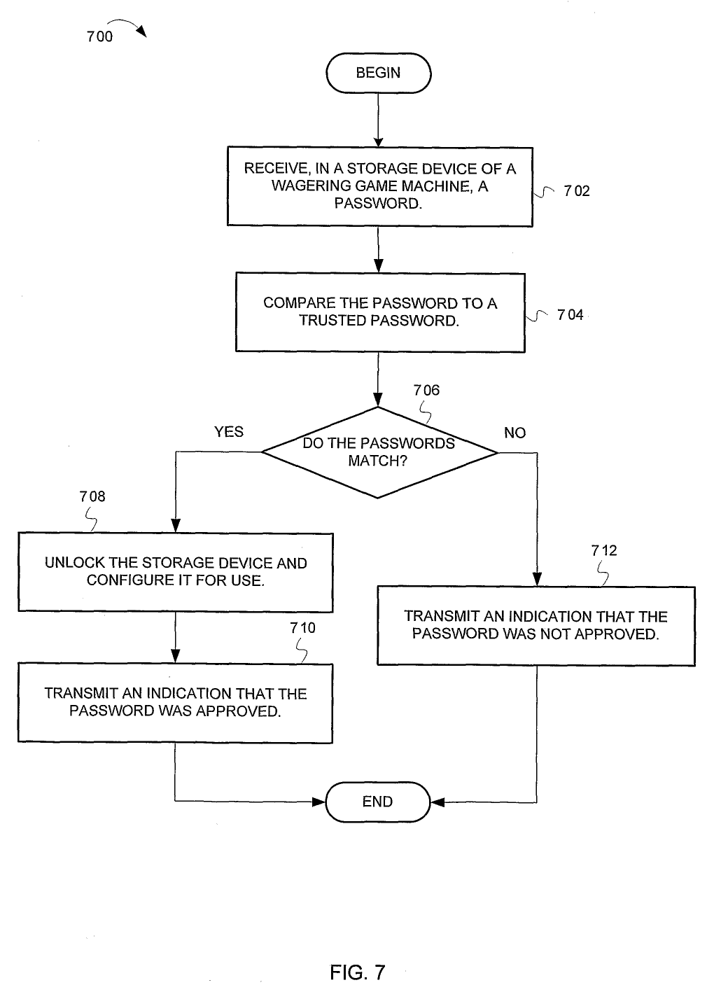

FIGS. 6 and 7 are discussed below. In particular, the discussion of FIGS. 6 and 7 describes embodiments of a wagering game device that are adapted to authenticate a storage device. In one embodiment, the operations of FIGS. 6 and 7 are performed before boot-up of a wagering game device's operating system. This description continues with a discussion of FIG. 6.

FIG. 6 is a flow diagram illustrating operations for authenticating a storage device in a wagering game device, according to example embodiments of the invention. The flow 600 begins at block 602.

At block 602, a storage device is detected in a wagering game machine. For example, a wagering game machine's trusted platform module 238 detects a storage device 236. The flow continues at block 604.

At block 604, a password is provided to the storage device. For example, the trusted platform module 238 transmits a password to the storage device 236. In one embodiment, the password can be an alphanumeric string or other suitable data string. The flow continues at block 606.

At block 606, a determination is made about whether the storage device approved the password. For example, the trusted platform module 238 determines whether the storage device 236 approved the password. If the password was approved, the flow continues at block 608. Otherwise, the flow continues at block 610.

At block 608, it is recorded that the storage device approved the password. For example, the trusted platform module 238 records an indication that the storage device 236 approved the password. From block 608, the flow ends.

At block 610, the wagering game machine is halted. For example, because the storage device does not approve the password, the trusted platform module 238 halts the wagering game device 206. In one embodiment, halting the wagering game device can include prohibiting the CPU 226 to boot-up an operating system, prohibiting the CPU 226 from executing instructions, alerting system operators, etc. The flow continues at block 612.

At block 612, it is recorded that the storage device did not approve the password. For example, the trusted platform module 238 records an indication that the storage device 236 did not approve the password. From block 612, the flow ends.

While the discussion of FIG. 6 describes operations that can be performed by embodiments of the trusted platform module 238, the discussion of FIG. 7 describes operations that can be performed by the storage device 236.

FIG. 7 is a flow diagram illustrating operations for a storage device responding to authentication requests in a wagering game machine, according to example embodiments of the invention. The flow begins at block 702.

At block 702, a password is received. For example, the storage device 236 receives a password from the trusted platform module 238. The flow continues at block 704.

At block 704, the password is compared to a trusted password. For example, the storage device 236 compares the password received at block 702 to a trusted password stored in a secure storage area (not shown), which is inaccessible to other components of the wagering game device 206. The flow continues at block 706.

At block 706, a determination is made about whether the passwords match. For example, storage device 236 compares the trusted password with the password received at block 702. If the passwords match, the flow continues at block 708. Otherwise, the flow continues at block 712.

At block 708, the storage devices are unlocked and configured for use. For example, after determining that the passwords match, the storage device 236 configures itself to fetch and/or store data in concert with wagering game operations performed by the wagering game unit 232 and/or other components of the wagering game device 206. The flow continues at block 710.

At block 710, an indication indicating the password was approved is transmitted. For example, the storage device 236 transmits to the trusted platform module 238 an indication that the password was approved. From block 710, the flow ends.

At block 712, an indication that the password was not approved is transmitted. For example, after determining the passwords do not match, the storage device 236 transmits an indication that the password was not approved. From block 712, the flow ends.

### Locked Wagering Game Content

According to embodiments, wagering game machines can include “locked” (i.e., unusable) wagering game content stored in the wagering game's storage device. The wagering game content is “locked” because it has been encrypted using a secret key, which is unknown to the wagering game machines. In order to “unlock” the content, wagering game machines can acquire the secret encryption keys over a wagering game network or through other means, possibly for a fee or other consideration. In one embodiment, wagering game content disposed on different portions of a storage device can require different keys for unlocking (i.e., decrypting) the content. As a result, wagering game manufacturers can sell wagering game machines including a plurality of wagering games, each of which has to be unlocked using a different secret encryption key.

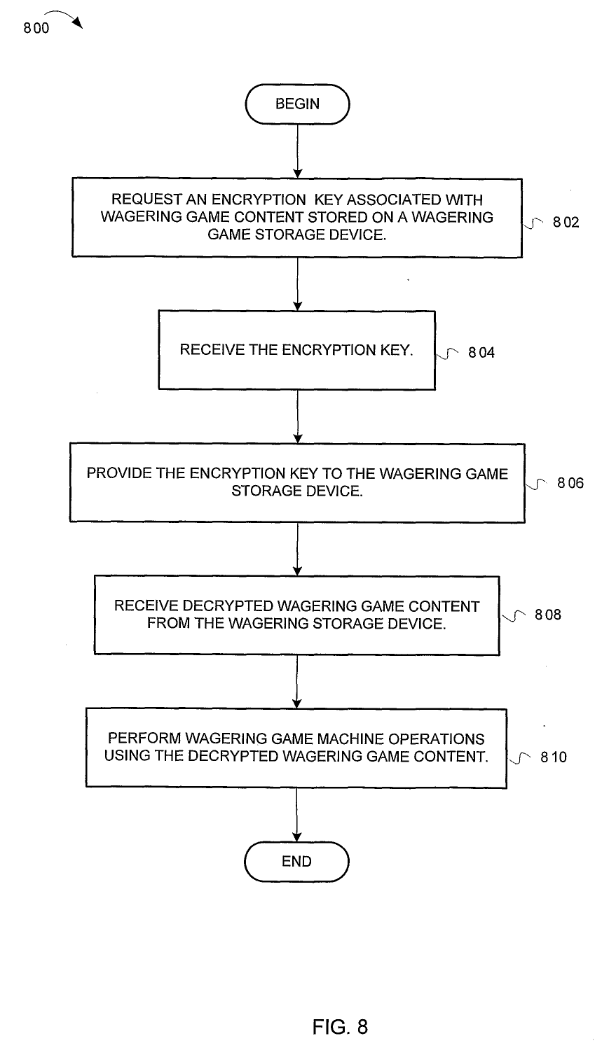

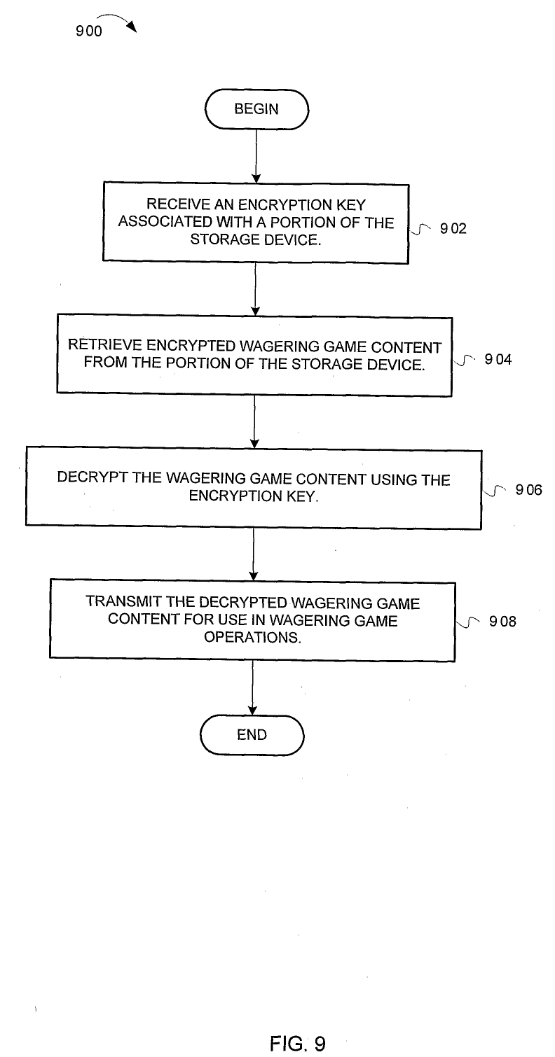

The discussion of FIGS. 8 and 9 describe operations for acquiring encryption keys and accessing locked wagering game content. This description continues with FIG. 8.

FIG. 8 is a flow diagram illustrating operations for procuring an encryption key for unlocking wagering game content, according to example embodiments of the invention. The flow 800 begins at block 802.

At block 802, an encryption key is requested, where the encryption key is associated with wagering game content on a storage device. For example, the wagering game unit 232 requests an encryption key from a wagering game server located on the wagering at network 204. In one embodiment, the encryption key can be associated with a portion of the storage media 240, but it can alternatively be associated with particular wagering game content, irrespective of the content's location on the storage media 240. In one embodiment, the request is accompanied by payment of money or other suitable consideration. The flow continues at block 804.

At block 804, the encryption key is received. For example, the wagering game unit 232 receives the encryption key from the wagering game server via the network interface unit 224 and I/O bus 222. The flow continues at block 806.

At block 806, the encryption key is provided to the wagering game's storage device. For example, the wagering game unit 232 transmits the encryption key to the storage device's encryption unit 234. Operations performed by the storage device 236 are described below, in the discussion of FIG. 9. The flow continues at block 808.

At block 808, decrypted wagering game content is received from the storage device. For example, the wagering game unit 232 receives decrypted wagering game content from the storage device 236. The flow continues at block 810.

At block 810, wagering game machine operations are performed using the decrypted wagering game content. For example, the wagering game unit 232 presents a wagering game, such as slots, using the decrypted (i.e., “unlocked”) wagering game content.

While FIG. 8 describes operations for procuring an encryption key, FIG. 9 describes operations for receiving the encryption key in a storage device and unlocking content using the encryption key. This description continues with FIG. 9.

FIG. 9 is a flow diagram illustrating operations for using an encryption key for unlocking wagering game content, according to example embodiments of the invention. The flow diagram 900 begins at block 902.

At block 902, an encryption key is received, where the encryption key is associated with wagering game content stored on a storage device. For example, the storage device's encryption unit 234 receives an encryption key that is associated with wagering game content stored on the storage media 240. In one embodiment, the encryption key is associated with wagering game content located within a range of addresses on the storage media 240. Alternatively, the encryption key can be associated with a wagering game content file, irrespective of the content's location on the storage media 240. The flow continues at block 904.

At block 904, encrypted wagering game content is retrieved from the storage device. For example, the encryption unit 234 retrieves from the storage media 240 encrypted wagering game content associated with the encryption key. In one embodiment, the encryption unit 234 retrieves encrypted wagering game content from a range of addresses on a magnetic platter of a hard disk drive. The flow continues at block 906.

At block 906, the encrypted wagering game content is decrypted using the encryption key. For example, the encryption unit 234 decrypts the encrypted wagering game content using the encryption key. The flow continues at block 908.

At block 908, the decrypted wagering game content is provided for use in concert with wagering game operations. For example, the encryption unit transmits the decrypted wagering game content to the wagering game unit 232 for use in wagering game operations, such as conducting a wagering game, presenting video content on the secondary display 210, updating device drivers for the peripheral components (e.g., payout mechanism 208), etc. From block 908, the flow ends.

Although the discussion of FIGS. 8 and 9 describes embodiments in which a storage device decrypts “locked” wagering game content, other embodiments include other components (e.g., the wagering game unit 232) capable of decrypting the locked wagering game content. As a result, wagering game device manufacturers can sell or otherwise deploy wagering game devices with locked content, even though those wagering game devices do not include storage devices capable of decrypting the content.

### Example Wagering Game Devices and Wagering Game Networks

This section describes example wagering game machines and wagering game networks with which embodiments of the invention can be practiced.

### Example Wagering Game Machine

FIG. 10 is a perspective view of a wagering game machine, according to example embodiments of the invention. As shown in FIG. 10, the wagering game machine 1000 can be a computerized slot machine having the controls, displays, and features of a conventional slot machine.

The wagering game machine 1000 can be mounted on a stand 1042 or it can be constructed as a pub-style tabletop game (not shown). As a result, the wagering game machine 1000 can be operated while players are standing or seated. Furthermore, the wagering game machine 1000 can be constructed with varying cabinet and display designs. The wagering game machine 1000 can incorporate any primary game such as slots, poker, or keno, and additional bonus round games. The symbols and indicia used on and in the wagering game machine 1000 can take mechanical, electrical, or video form.

As illustrated in FIG. 10, the wagering game machine 1000 includes a coin slot 1002 and bill acceptor 1024. Players can place coins in the coin slot 1002 and paper money or ticket vouchers in the bill acceptor 1024. Other devices can be used for accepting payment. For example, credit/debit card readers/validators can be used for accepting payment. Additionally, the wagering game machine 1000 can perform electronic funds transfers and financial transfers to procure monies from financial accounts. When a player inserts money in the wagering game machine 1000, a number of credits corresponding to the amount deposited are shown in a credit display 1006. After depositing the appropriate amount of money, a player can begin playing the game by pushing play button 1008. The play button 1008 can be any play activator used for starting a wagering game or sequence of events in the wagering game machine 1000.

As shown in FIG. 10, the wagering game machine 1000 also includes a bet display 1012 and one or more “bet” buttons on the panel 1016. The player can place a bet by pushing one or more of the bet buttons on the panel 1016. The player can increase the bet by one or more credits each time the player pushes a bet button. When the player pushes a “bet one” button 1016, the number of credits shown in the credit display 1006 decreases by one credit, while the number of credits shown in the bet display 1012 increases by one credit.

A player may end the gaming session or “cash-out” by pressing a cash-out button 1018. When a player cashes-out, the wagering game machine 1000 dispenses a voucher or currency corresponding to the number of remaining credits. The wagering game machine 1000 may employ other payout mechanisms such as credit slips (which are redeemable by a cashier) or electronically recordable cards (which track player credits), or electronic funds transfer.

The wagering game machine also includes a primary display unit 1004 and a secondary display unit 1010 (also known as a “top box”). The wagering game machine may also include an auxiliary video display 1040. In one embodiment, the primary display unit 1004 displays a plurality of video reels 1020. According to embodiments of the invention, the display units 1004 and 1010 can include any visual representation or exhibition, including moving physical objects (e.g., mechanical reels and wheels), dynamic lighting, and video images. In one embodiment, each reel 1020 includes a plurality of symbols such as bells, hearts, fruits, numbers, letters, bars or other images, which correspond to a theme associated with the wagering game machine 1000. Additionally, the wagering game machine 1000 also includes an audio presentation unit 1028. The audio presentation unit 1028 can include audio speakers or other suitable sound projection devices.

In one embodiment, the wagering game machine 1000 can simultaneously (or virtually simultaneously) authenticate wagering game files and/or components while conducting wagering games, as described herein.

It should be noted that although a generally non-portable wagering game machine has been described, the systems and methods described herein may be incorporated into a portable or handheld wagering game machine. Further, the systems and methods may further be incorporated into mobile devices such as personal digital assistants (PDAs), cellular phones, and other devices having suitable memory and processors to implement the systems and methods described herein.

### General

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description.

Herein, block diagrams illustrate example embodiments of the invention. Also herein, flow diagrams illustrate operations of the example embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, although the flow diagrams depict serial operations, certain embodiments could perform certain of those operations in parallel.

1. A wagering game device comprising:
a wagering game processor operable to receive a wager for a wagering game;
a main memory operable to store wagering game content associated with the wagering game; and
a storage device including,
an encryption unit operable to encrypt the wagering game content; and
a storage medium operable to store the wagering game content that has been encrypted by the encryption unit.

2. The wagering game machine of claim 1, wherein the encryption unit is further operable to decrypt the wagering game content that has been encrypted by the encryption unit.

3. The wagering game machine of claim 1, wherein the storage medium includes a medium selected from the group consisting of magnetic disk, flash memory, or optical medium.

4. The wagering game machine of claim 1, wherein the encryption unit is operable to encrypt the wagering game content according to the Triple Digital Encryption Standard.

5. The wagering game machine of claim 1, wherein the wagering game content includes audio content, video content, or instructions for presenting the wagering game.

6. A machine readable medium encoded with instructions which when executed by a wagering game device cause the wagering game device to perform operations comprising:
transmitting a password to a storage device;
determining whether the storage device approved the password;
if the storage device approved the password, processing wagering game content associated with a wagering game; and
if the storage device did not approve the password, halting the wagering game device.

7. The machine readable medium of claim 6, wherein the password includes an alphanumeric character string.

8. The machine readable medium of claim 6, wherein the storage device includes a magnetic disk, an optical medium, or a flash memory.

9. The machine readable medium of claim 6, wherein the processing of wagering game content includes using the wagering game content for receiving a wager for a wagering game.

10. The machine readable medium of claim 6, wherein wagering game content has been encrypted by the storage device.

11. A machine readable medium encoded with instructions which when executed by a machine cause the machine to perform operations comprising:
receiving, in a storage device, an encryption key associated with encrypted wagering game content stored on a storage medium;
retrieving the encrypted wagering game content from the storage medium;
generating, using the encryption key, a decrypted version of the encrypted wagering game content, the generating occurring in the storage device; and
providing the decrypted version of the wagering game content for use in receiving a wager for a wagering game.

12. The machine readable medium of claim 11, wherein the wagering game content includes instructions for conducting the wagering game.

13. The machine readable medium of claim 11, wherein the wagering game content includes audio content or video content for presentation during the wagering game.

14. The machine readable medium of claim 11, wherein the storage device includes a hard disk drive, DVD drive, CD-ROM drive, a flash memory device.

15. The machine readable medium of claim 11, wherein the wagering game content includes instructions for receiving a wager as part of a wagering game.

16. A method comprising:
receiving an encryption key associated with encrypted wagering game content, the encrypted wagering game content stored on a storage device;
providing the encryption key to the storage device, wherein the storage device is capable of using the encryption key for decrypting the encrypted wagering game content; and
receiving a decrypted version of the wagering game content from the storage device.

17. The method of claim 16 further comprising:
remitting value, over a network, in consideration for receipt of the encryption key.

18. The method of claim 16 further comprising:
using the decrypted version of the wagering game content for presenting a wagering game.

19. The method of claim 16 further comprising:
remitting monetary value for receipt of the encryption key.

20. The method of claim 16, wherein the encryption key is received over a communications network.
